(19) United States
(12) Patent Application Publication
(10) Pub. No.: US 2001/0011275 A1
(43) Pub. Date: Aug. 2, 2001

(54) Distributive web page management system

(76) Inventors: Benjamin Lin, Taipei (TW); Chung-Chih Lin, Taipei (TW); Wen-Hao Hsu, Taipei (TW)

Correspondence Address: Powell, Goldstein, Frazer & Murphy, LLP, P.O. Box 97233, Washington, DC, 20090-7223, US

(21) Appl. No.: 09/772,341

(22) Filed: Jan. 30, 2001

(30) Foreign Application Priority Data
Jan. 31, 2000 (TW) 89101664

(51) Int. Cl. G06F 17/30

(52) U.S. Cl. 707/9; 707/10

(57) ABSTRACT

A distributive web page management system for managing web page editing data of a website so that an editor can finish web page edition from any end user computer on the network. When a web page management system procedure is initiated, the user is registered in the system. The management system then downloads user assigned web page data to the end user computer according to predetermined privileges. The user edits web pages using the downloaded data and sends the edited web page data back to the server host. The management system replace the original data by the received web page data edited by the user according to his privilege so as to update the web page contents, thus completing the web page editing procedure.

### BACKGROUND OF THE INVENTION

1. Field of Invention

The present invention relates to a web page management system and the corresponding method. More particularly, it relates to a distributive web page management system and method that allows a user to log on and edit web pages from any location on the network, rendering the user mobility and convenience.

2. Related Art

With the tremendous progress in computer hardware/software technologies and the sophisticated and rapid development in network traffic, the modem society has become an information society characterized in mass information communications. The communications of global information become so often that information is continuously generated and transmitted in different forms. Therefore, one can readily obtain a huge amount of information by simply using a computer to link to websites all over the world. The most important information providers and transmitting media in such an information network are the websites distributed in the network. All data exchanging in the network and the messages that network users can receive are stored in websites and for network users to download or browse through web pages edited by the respective web masters.

Due to the continuous development in network communications, people have more needs for information. Thus, the web page contents have to be renovating continuously so as to attract network users and to update information provided. Modifying the web page contents involves web page format editing and selections of information. The network technicians have to master network related knowledge such as TCP/IP, Java, ActiveX and HTML in order to have a more accurate and effective hold of the setup, update and maintenance of a website. However, in addition to network-related information the website contents also involves other types of knowledge, depending upon the theme and goal of the website. Therefore, aside from network professionals, information providers with other talents are often needed too in order to finish the edition of all the web page contents of a website.

After a website is established, the web page contents have to be continuously updated or revised for visitors to receive the latest information and for providing more innovative ideas. Thus, the information in web pages will be downloaded very often. For example, a normal visitor can simply download and read or is asked to enter data in a provided format in an interactive mode.

Under this hierarchical privilege structure, the identity verification and privilege distinction are necessary procedures. The distinction among the maintainers, editors, and normal visitors should be separately and rigorously controlled. The editing management system of the web pages in a website is thus a necessary tool. Most of the current conventional web page editing management tools cannot simultaneously provide the mobility and convenience for privilege distinction and editing management. Taking Microsoft FrontPage as an example, when the central control system of Microsoft FrontPage is mounted on a network server, the web page editor has to set up a relevant transmission protocol or even drivers in an assigned client device in advance if he wants to the client device other than the server host to do the editing job. Under this circumstance, the web page editing can only be performed on the server host and a few client devices being set up already. FIG. 1 shows that a Microsoft FrontPage central control system is mounted on a network server 10 and only the assigned client device 20 is set up with the relevant transmission protocol. The editor can only log on from the assigned client device 20 and perform the web page editing and data transmission. When the editor travels far from the server host 10 and the assigned client device 20 and goes to any one of the unassigned client devices 30, 40, 50, 60, then he is neither able to make use of the assigned client device 20 nor log on as a qualified web page editor from the unassigned client devices 30, 40, 50, 60 to transmit any data for web page editing. Therefore, the web page data updating and editing cannot be performed immediately, and the editor has to wait until he finishes his trip and goes back to the assigned device 20. In a modem society, this limitation will greatly lower the convenience of the work and the speed or mobility of updating the web page information.

Furthermore, when the web page edited on the client device contains hyperlink settings and all web pages have to be moved to a target website, the link relations among them and the corresponding paths may be different. So the edited web pages have to set up again. If the web pages have a rather complicated structure, it then takes more time and efforts for a technician to search and debug in order to have the correct link relations. Moreover, subsequent web page data maintenance will become more difficult. It is therefore highly desirable to have a more convenient web page management tool so that the web page designer can complete the web page editing procedure with mobility and convenience and readily set up web page links when they are moved to the target website to alleviate subsequent maintenance work.

### SUMMARY OF THE INVENTION

In view of the foregoing, the traditional web page management tools cannot satisfy the requirement for security and mobile convenience of web page management. Therefore, the present invention provides a distributive web page management system that manages web page editing data in a website so that a web page editor can complete the web page editing from any client computer device on the network.

The disclosed distributive web page management system contains a privilege database and an operation processing module mounted in a network. The privilege database includes user identity data, verification data and privilege data recording the editing privilege of a user on web pages of the website.

First, the user can log on after the distributive web page management system procedure starts. Once the logon data are verified, the management system downloads the user assigned web page data according to the predetermined privilege settings in the privilege database and sends them to the client computer device for the user to edit the web pages. When the editing is finished, the user uploads the edited web page data to the server host. The management system receives the edited web page data and substitutes them for the original data to update the contents of the new web pages.

### BRIEF DESCRIPTION OF THE DRAWINGS

The present invention will become more fully understood from the detailed description given hereinbelow illustration only, and thus are not limitative of the present invention, and wherein:

FIG. 1 is a schematic view of the operation management relation between the server end and the client end of a conventional web page editing management system;

FIG. 2 is a schematic view of the operation management relation between the server end and the client end of a web page editing management system of the present invention;

FIG. 3 is an operation flowchart of performing web page editing using the disclosed distributive web page management system by a user;

FIG. 4 is a preferred embodiment flowchart describing how a web page editing management system user logs on according to the invention;

FIG. 5 is a flowchart of the processing action in the web page editing using the disclosed distributive web page editing system;

FIG. 6 is an operational flowchart of using the disclosed distributive web page management system to download web page data;

FIG. 7 is an operational flowchart of the web page content analysis and downloading in the user download list of the disclosed distributive web page management system;

FIG. 8 is an operational flowchart of the web page content analysis and uploading in the user upload list when the disclosed distributive web page management system accepts web page data uploading;

FIG. 9 is an operational flowchart of the web page content analysis and uploading in the user upload list of the disclosed distributive web page management system;

FIG. 10 is a schematic view of a login window for the user to log on to the disclosed web page management system; and

FIG. 11 is a schematic view of an operation interface window provided by the disclosed web page management system for the user to download or upload.

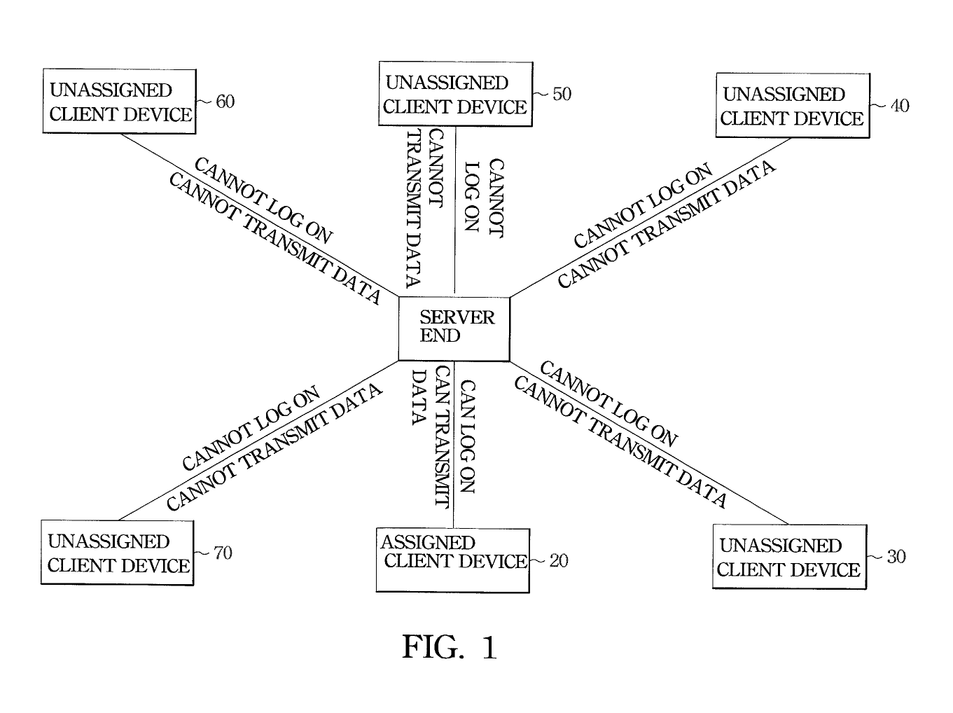

### DETAILED DESCRIPTION OF THE INVENTION

The present invention provides a distributive web page management system for managing web page editing data in a website so that a web page editor can finish web page editing tasks from any client computer device on the network without being limited in a restricted area. The invention also provides a transmission protocol for communications between the device and a host server.

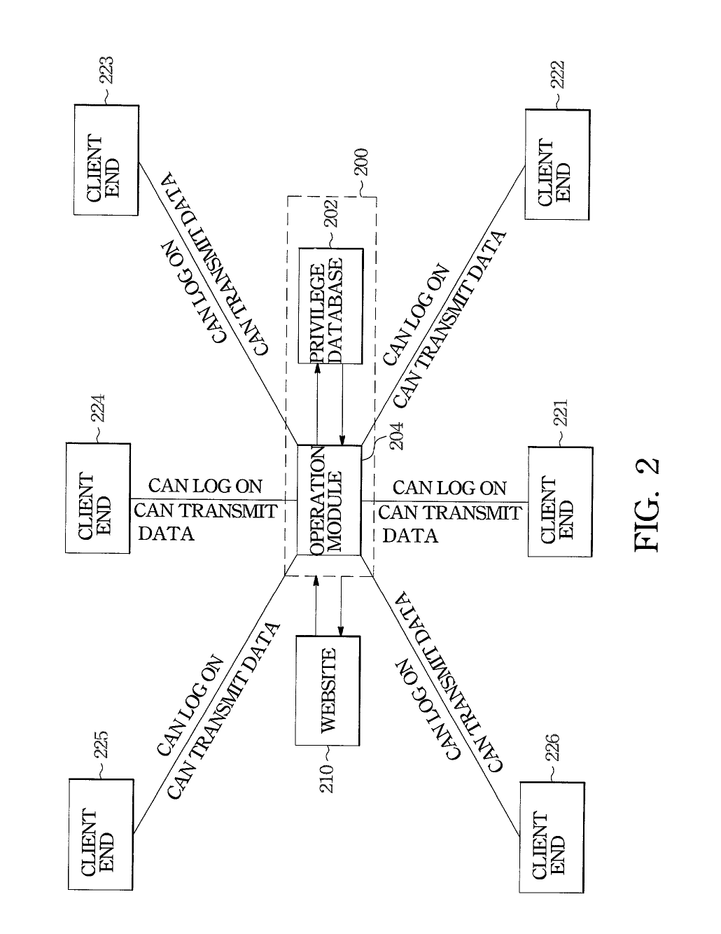

As shown in FIG. 2, the disclosed distributive web page management system 200 is established in a network to manage web page editing data in a website 210. The distributive web page management system 200 contains a privilege database 202 and an operation processing module 204. The privilege database 202 contains user identity data, verification data and privilege data. The privilege data record the editing privilege of a user toward web pages in the website 210, i.e., the items in the web pages that the user can modify. The operation processing module 204 controls the operation of management procedures. Under the management of the distributive web page management system, a system user, which is the editor with web page data editing privilege, can use any of the client (user end) computer devices 221, 222, 223, 224, 225, 226 on the network to retrieve and edit web page data from the website 210 allowed by his privilege through the network. For example, the editor can first create a new web page on the client computer 221 and save it to the website 210. Then he can download the previously edited web page data from the client computer 223 and save it back to the website 210. The management operation mode of the disclosed distributive web page management system is described as follows.

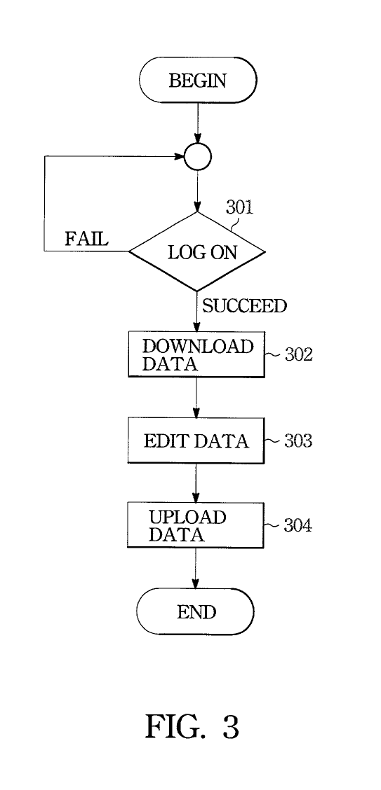

Referring to FIG. 3, once the disclosed distributive web page management system procedure is started, the user can log on (step 301). If there is any error in input, the login data will be determined invalid and the management system returns to the status before login for the user to log on again. When the login data are successfully verified, the user can start to edit web pages. The distributive web page management system in the server host downloads the user assigned web page data and sends them to the user-end computer device according to the predetermined privilege settings in the privilege database (step 302). The user can then continue web page editing of the downloaded data (step 303). When the editing is finished, the user uploads the edited web page data to the server host (step 304). This then completes the web page editing procedure.

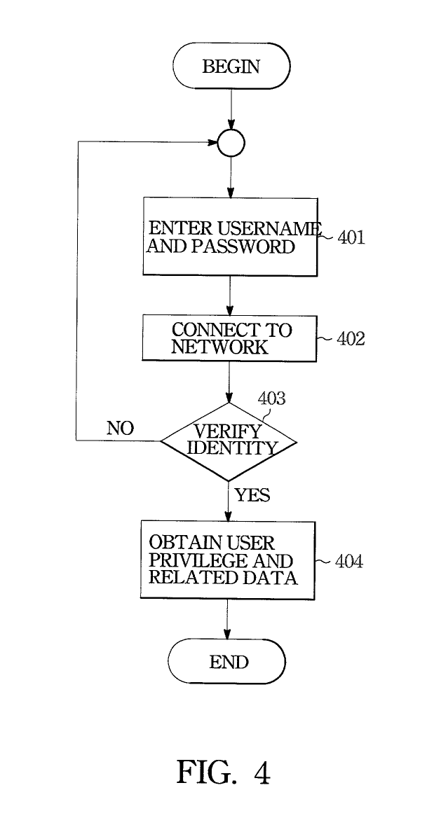

FIG. 4 shows a preferred embodiment flowchart of user login procedure in FIG. 3. The user first enters the username and the corresponding password at the user-end computer (step 401) and connects to the network (step 402) for transmitting the username and password to the web page management system at the server end. The web page management system then verify the inputs according to the previously prepared privilege data, performing the identity verification procedure (step 403). If the inputs have some errors, e.g., incorrect username or password, then the management system will not allow the user to enter the system and return to the status before login. The user cannot obtain any web page editing power and has to go through the login procedure again. When the username and password are both correct, the user is then considered as a legal user with some web page editing privilege. The management system then obtains relevant data such as the user privilege according to his identity (step 404) and starts the data downloading procedure for the user to edit web pages. In the current preferred embodiment, the user-end device has the correct login format for the management system.

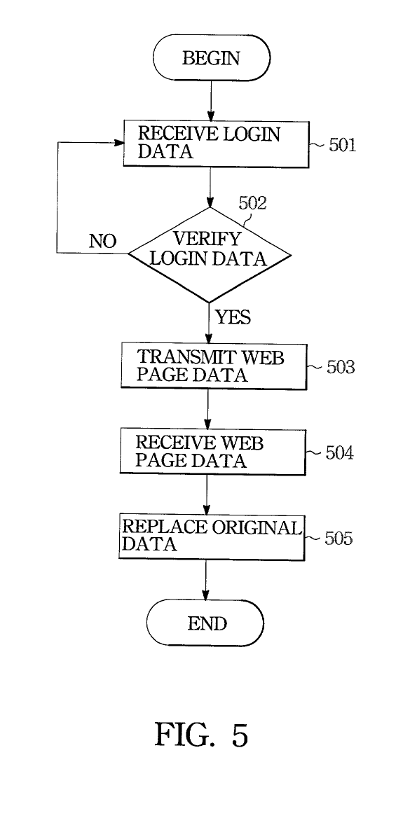

With reference to FIG. 5, when the distributive web page management system procedure is started, the system enters the user login status for the user to log on and for receiving the login data (step 501). After receiving the login data, the system verifies the entered according to the previously determined privilege data (step 502). If the login data are invalid, the system returns to the status of waiting for login for the user to log on again (step 501) or for other users to log on. If the entered login data are verified to be correct, then the user's identity is recognized and his editing privilege is loaded into the system. The system then transmits web page data to the user-end computer according to his request and his privilege for the user to edit (step 503). When the editing of downloaded web pages is finished, the user uploads the edited web page data to the server host and the management system stores these web page data (step 504). The system then replaces original data with the new data according to the user's privilege (step 505) so as to update the web page contents. This completes one web page editing procedure.

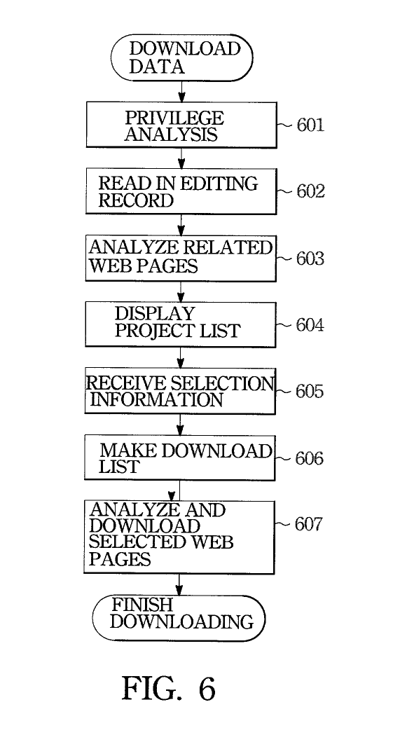

Referring to FIG. 6, when the web page editor logs on to the management system and requests for data downloading, the management system immediately performs a privilege analysis (step 601) to determine the user's editing privilege, i.e., which portion of the web pages the user can modify, according to the privilege data previously determined and stored in the system.

When the user's privilege is determined, the system will read in a user editing record file (step 602) in order to know the web page contents that the user had previously edited. According to the data stored in the user editing record file, the management system can control all relevant web page data within the user's privilege, whereby to analyze the relation contents in the edited web pages (step 603). The relation contents include the web pages and elements related by the links and hyperlinks in the edited web pages and the locations and paths thereof. After all the related contents in the edited web pages are found, the system will display the web pages and related web pages within the user's privilege in a list for the user to select (step 604).

At the moment, the user can see in the user-end computer monitor a list of all web pages collected by the management system according to his privilege. Therefore, he can click the web pages he wants to edit in the list and send back the selection information. After the management system receives this web page selection message (step 605), it will form a list of the assigned web pages according to the user's request (step 606) and perform the web page content analysis and downloading according to the list (step 607).

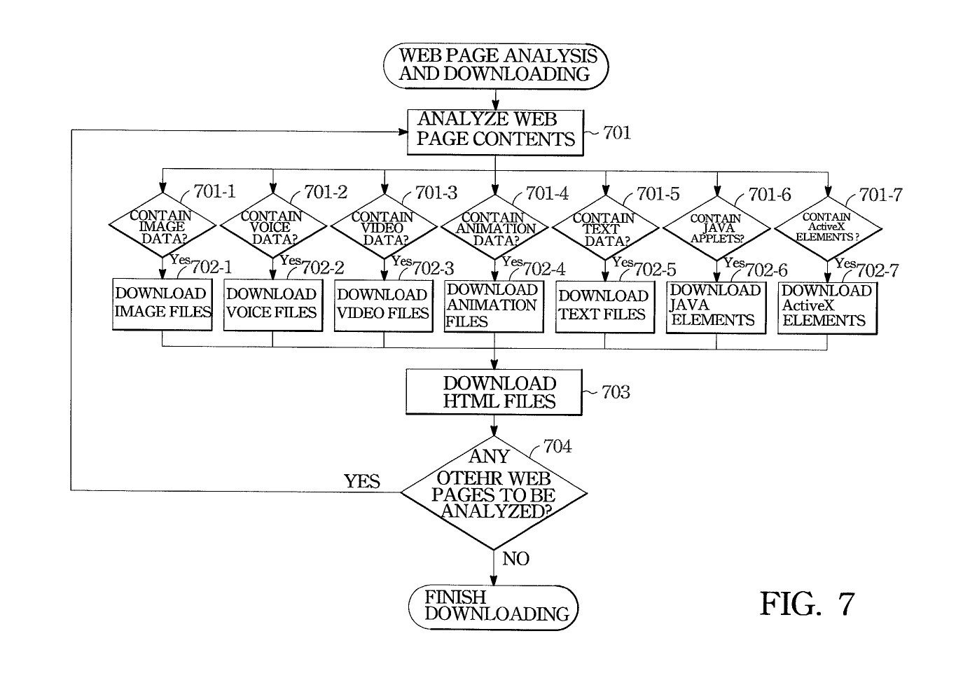

With reference to FIG. 7, the management system first analyzes the web page contents requested to download in the selection list (step 701) so as to know whether each assigned web page contains image data (step 701-1), voice data (step 701-2), video data (step 701-3), animation data (step 701-4), text data (step 701-5), Java applets (step 701-6), or ActiveX elements (step 701-7). If the web page contains image data, then the image files are downloaded (step 702-1). If the web page contains voice data, then the voice files are downloaded (step 702-2). If the web page contains video data, then the video files are downloaded (step 702-3). If the web page contains animation data, then the animation files are downloaded (step 702-4). If the web page contains text data, then the text files are downloaded (step 702-5). If the web page contains Java applets, then the Java elements are downloaded (step 702-6). If the web page contains Active elements, then the ActiveX elements are downloaded (step 702-7). Finally, the HTML (hypertext markup language) is downloaded (step 703). Afterwards, the system will check if there is any other web page to be downloaded (step 704). If there is, the web page analysis task is continued (repeating step 701) followed by the download procedure. When the assigned web page analysis is completed, then the download procedure is finished.

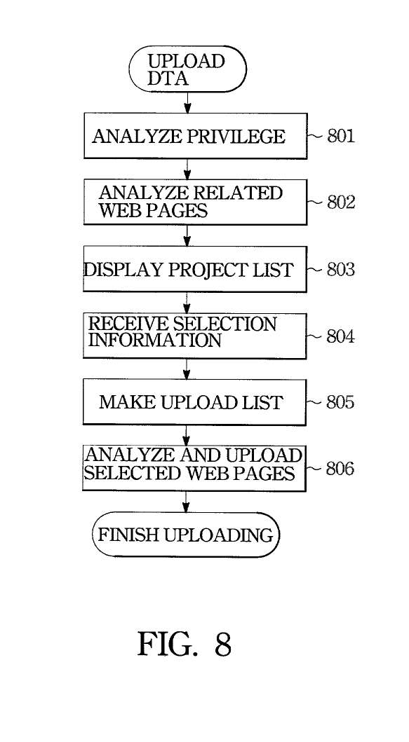

With reference to FIG. 8, when the web page editor of the management system finishes his editing job and requests to upload the edited web page data to the server host where the management system is located, the management system will perform the privilege analysis again (step 801). The privilege analysis can be performed according to the previously determined privilege data stored in the system or can use the privilege analysis result obtained before the data downloading. The management system finds out all the modified related web pages according to this privilege analysis result (step 802). All related web pages are then displayed in a list (step 803) for the user to select web pages to upload.

The user can see on his computer monitor the edited web pages listed by the management system. The user can then click the web pages he wants to upload and send the selection information back to the system. After receiving the web page selection information (step 804), the management system performs web page content analysis and uploading (step 806) according to the upload web page list collected by the system.

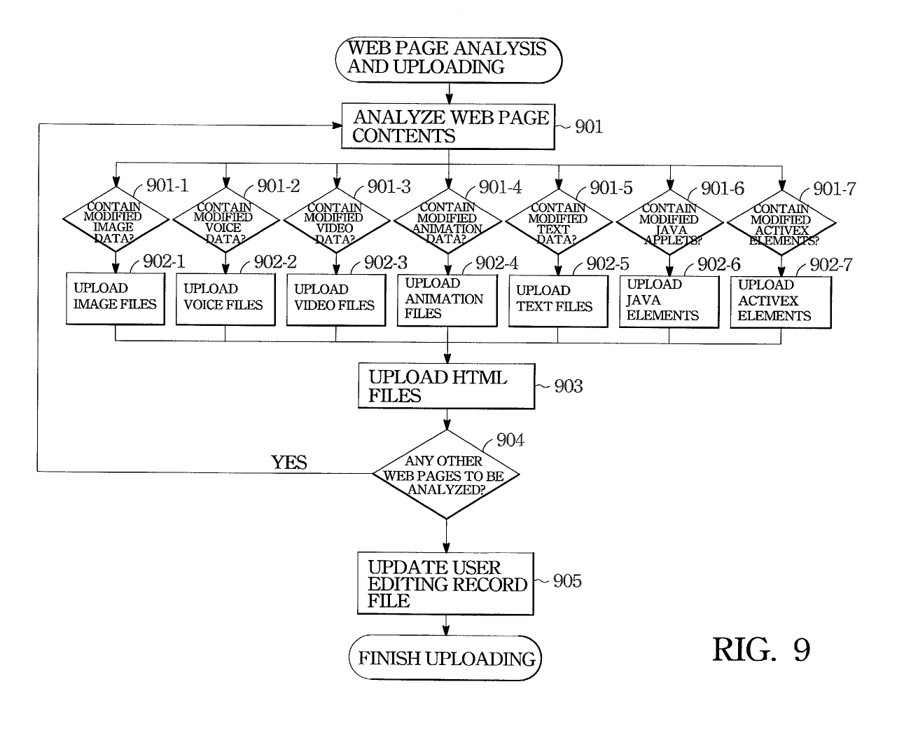

Referring to FIG. 9, the management system first analyzes all the web page contents in the assigned upload list (step 901). The system then checks whether each of the assigned web page contains modified image data (step 901-1), modified voice data (step 901-2), modified video data (step 901-3), modified animation data (step 901-4), modified text data (step 901-5), modified Java applets (step 901-6), or modified ActiveX elements (step 901-7). If the image data in the web page are modified, then the image files are uploaded (step 902-1). If the voice data in the web page are modified, then the voice files are uploaded (step 902-2). If the video data in the web page are modified, then the video files are uploaded (step 902-3). If the animation data in the web page are modified, then the animation files are uploaded (step 902-4). If the text data in the web page are modified, then the text files are uploaded (step 902-5). If the Java applets in the web page are modified, then the Java elements are uploaded (step 902-6). If the ActiveX elements in the web page are modified, then the Active elements are uploaded (step 902-7). Finally, the HTML file is uploaded (step 903). The system then checks if there is any other web page to be uploaded (step 904). If there is, then the web page analysis is continued (step 901) and the uploading procedure continues. After the assigned web page analysis and uploading procedure is completed, the user editing record file is modified accordingly (step 905) and the uploading procedure finishes.

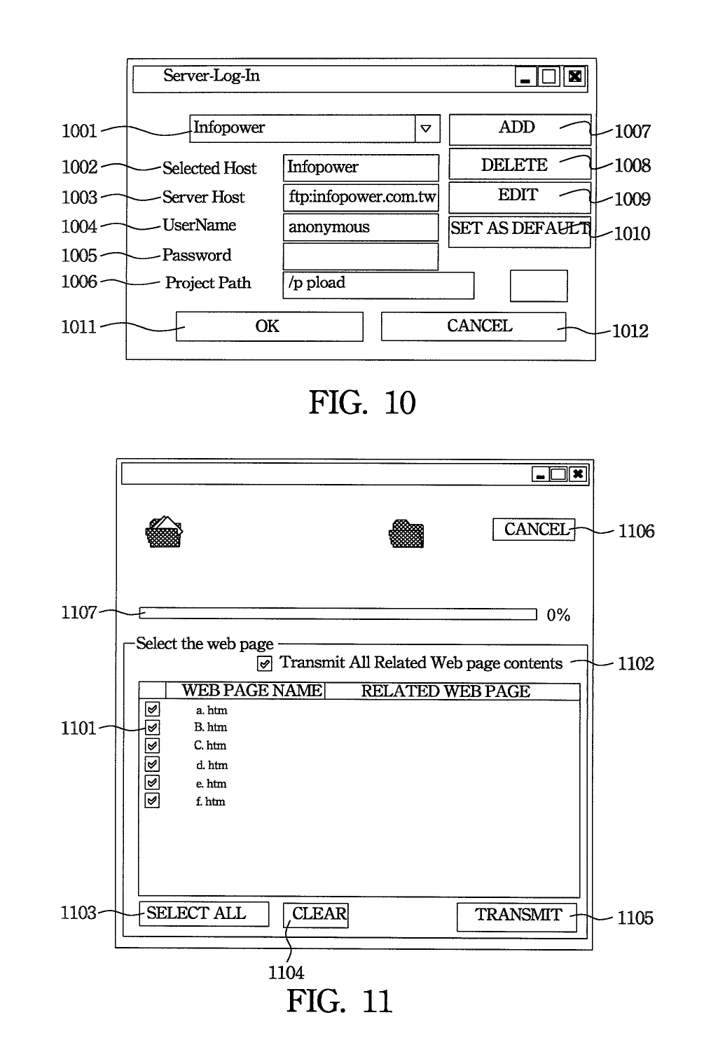

With reference to FIG. 10, the user performs step 401 in the window displayed. A space 1001 with a pull-down menu provides a catalog of the server host for the user to log on. A space 1002 displays the name of the selected host. A space 1003 allows the user to enter the network address of the server host for establishing network connection. A space 1004 is provided for the user to enter his username, which stands for the user's identity whereby the web page management can determine the user's privilege. A space 1005 is provided for the user to enter the corresponding password for verification. A space 1006 displays a project catalog. When the user wants to classify or file previously edited contents into different projects, he can select the project he wants to edit in this space. This then establishes the model of data classifications so as to avoid transmission data of big sizes and to minimize the analysis range when the management system performs web page analyses. When the user selects a specific project item, the system only needs to analyze and transmit the web pages referred in the assigned project, reducing the load in steps 503 through 505.

The right hand side of the window is listed with all function keys. The ADD key 1007 adds a new server host and its path into the catalog. The DELETE key removes an unnecessary item from the host catalog. The EDIT key can modify existing host names or paths. The SET AS DEFAULT key 1010 can change the default host machine so that the user connects to this default host without changing or inputting any information. When all login data are completed, the user can press the OK key 1011 to finish setting and start the network connection. After registering the data on the selected host, the user can then start to perform web page editing. If the user changes his mind at any stage of the login procedure, he can always use the CANCEL key 1012 to abandon the operations being processed.

With reference to FIG. 11, the display window 1101 lists the web page catalog within the user's privilege or projects. The user can select the web pages he wants to retrieve from the catalog. The space 1102 indicates whether the user wants to transmit all related web page contents. The SELECT ALL key can select all web pages in the catalog without clicking one by one. The CLEAR key 1104 can clear all selected web page items. The TRANSMIT key 1105 finishes the selection and transmits the selection information to the web page management system for data transmission. The CANCEL key 1106 can terminate the process of data transmission. The space 1107 shows the transmitted data percentage.

In summary, the disclosed distributive web page management system controls the edition and storage of web page data and has the following advantages:

1. Distributivity: The user can perform web page editing from any client computer device on the network without being limited by the driver and transmission protocol between the computer and the server.

2. Activity: The system provides a network content analysis function that can collect related data referred in the web pages (such as images, voices, video signals or other web pages) and download or upload together. The user does not need to search and select individually.

3. Consistency: When uploading data, the system will automatically detect all edited data to ensure the consistency of the data on the server.

4. Convenience: The user can complete data uploading or downloading with only one key.

5. Safety: Through the privilege control, each user can only edit and modify data within his privilege, ensuring the security of the data.

Furthermore, the distributive web page editing management system can be mounted according to practical needs on a server of a cable television, the Internet, a local area network (LAN), a wide area network (WAN) so as to build a network-based web page management system, achieving the goals of distributivity, activity, consistency, convenience and safety.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A web page management system mounted on a network for controlling the modification of web page contents in a website so that a user with the privilege to edit can retrieve and modify web page contents from any client device on the network, said system comprising:
a privilege database comprising user identity data and privilege data, the privilege data recording the web page items on the website that the user can edit and modify within his privilege; and
an operation processing module, which performs the following steps to control the web page content changes:
receiving user login data transmitted from a client device, the login data containing identity data;
checking whether the login data is valid and terminating the procedure if the login data are not recorded in the privilege database and thus invalid;
transmitting the web page data within the user's privilege to the client device when the login data are valid;
receiving edited web page data transmitted from the client device; and
updating the web page data within the user's privilege.

2. The system of claim 1, wherein the privilege database contains verification data.

3. The system of claim 2, wherein the login data contain verification data.

4. The system of claim 3, wherein the step of checking whether the login data is valid comprises the step of checking whether the verification data in the login data are the same as the verification data recorded in the privilege database and the login data are invalid if they are not the same.

5. The system of claim 1, wherein the login data contain assigned project items which include some or all the web page contents allowed according to the user's privilege.

6. The system of claim 5, wherein the step of transmitting web page data within the user's privilege to the client device transmits some or all the web page contents referred in the assigned project.

7. The system of claim 1 further comprising a privilege analysis step after the login data are determined to be valid and before the web page data within the user's privilege are transmitted to the client device, wherein the privilege analysis determines privileged web page contents that can be edited and modified by the registered user according to the privilege data.

8. The system of claim 1 further comprising the step of reading in a user editing record file after the login data are determined to be valid and before the web page data within the user's privilege are transmitted to the client device, wherein the user editing record file contains editing records previously finished by the user.

9. The system of claim 8 further comprising the step of updating the user editing record file after the step of receiving web page data.

10. The system of claim 8 further comprising the step of analyzing web page relations after reading in the user editing record file and before the web page data within the user's privilege are transmitted to the client device, wherein the web page relations include the related web pages and elements referred through links and hyperlinks and the storage locations and paths thereof in the privileged web pages of the user.

11. The system of claim 10 further comprising the step of displaying a privileged web page list containing the privileged web pages and their related web pages that can be modified by the user within his privilege.

12. The system of claim 11 further comprising the step of receiving user download selection information after displaying the web page list and before the web page data within the user's privilege are transmitted to the client device, wherein the user download selection information contains a list of assigned web pages to be edited and modified by the user.

13. The system of claim 12 further comprising the step of making a download selection list after the user download selection information is received and before the web page data within the user's privilege are transmitted to the client device, wherein the download selection list contains the assigned editing web page list requested by the user in the user download selection information.

14. The system of claim 13 further comprising the step of analyzing web page contents after the user download selection information is received and before the web page data within the user's privilege are transmitted to the client device, wherein the step of analyzing web page contents analyzes all elements contained in each of the assigned web pages to be edited to find out if it contains image data, voice data, video data, animation data, text data, Java applets, and ActiveX elements.

15. The system of claim 14, wherein the step of transmitting the web page data within the user's privilege to the client device transmits the image data if the assigned web page to be edited contains image data.

16. The system of claim 14, wherein the step of transmitting the web page data within the user's privilege to the client device transmits the voice data if the assigned web page to be edited contains voice data.

17. The system of claim 14, wherein the step of transmitting the web page data within the user's privilege to the client device transmits the video data if the assigned web page to be edited contains video data.

18. The system of claim 14, wherein the step of transmitting the web page data within the user's privilege to the client device transmits the animation data if the assigned web page to be edited contains animation data.

19. The system of claim 14, wherein the step of transmitting the web page data within the user's privilege to the client device transmits the text data if the assigned web page to be edited contains text data.

20. The system of claim 14, wherein the step of transmitting the web page data within the user's privilege to the client device transmits the Java elements if the assigned web page to be edited contains Java applets.

21. The system of claim 14, wherein the step of transmitting the web page data within the user's privilege to the client device transmits the ActiveX elements if the assigned web page to be edited contains ActiveX elements.

22. The system of claim 1, wherein the step of transmitting the web page data within the privilege of the login identity transmits hypertext markup language (HTML) files.

23. The system of claim 1, wherein the step of receiving the web page data transmitted from the client device is executed after receiving the user's request for uploading data.

24. The system of claim 1, wherein the step of receiving web page data further comprises a privilege analysis step which determines web page contents that can be modified by the login user.

25. The system of claim 1, wherein the step of receiving web page data further comprises the step of analyzing web page relations in order to detect all related web pages and elements referred through links and hyperlinks and the storage locations and paths thereof in the assigned modified web page.

26. The system of claim 1, wherein the step of receiving web page data further comprises the step of displaying a list of edited web pages, wherein the edited web page list contains all edited and modified web pages in the assigned web pages to be edited.

27. The system of claim 26, wherein the step of receiving web page data further comprises the step of receiving user upload selection information after displaying the edited web page list, the user upload selection information comprising a list of edited web pages to be uploaded as requested by the user.

28. The system of claim 27, wherein the step of receiving web page data further comprises the step of making an upload list after receiving the user upload selection information, the upload list contains the edited web pages to be uploaded as requested by the user in the user upload selection information.

29. The system of claim 28, wherein the step of receiving web page data further comprises the step of analyzing web page contents after the user upload selection information is received, the step of analyzing web page contents analyzes each of the edited web page in the upload list and determines whether any of the image data, voice data, video data, animation data, text data, Java applets and ActiveX elements contained therein is modified.

30. The system of claim 29, wherein the system receives the edited image data if the image data in the edited web page are modified.

31. The system of claim 29, wherein the system receives the edited voice data if the voice data in the edited web page are modified.

32. The system of claim 29, wherein the system receives the edited video data if the video data in the edited web page are modified.

33. The system of claim 29, wherein the system receives the edited animation data if the animation data in the edited web page are modified.

34. The system of claim 29, wherein the system receives the edited text data if the text data in the edited web page are modified.

35. The system of claim 29, wherein the system receives the edited Java elements if the Java applets in the edited web page are modified.

36. The system of claim 29, wherein the system receives the edited ActiveX elements if the Active elements in the edited web page are modified.

37. The system of claim 1, wherein the step of receiving web page data comprises the step of receiving HTML files.

38. The system of claim 1, wherein the web page management system is established in a network system selected from the group comprising the local area network (LAN) system, the wide area network (WAN) system, the Internet system; and the cable television network system.

39. A web page management method, which controls the modification of web page contents on a network and enables a user with editing privilege to retrieve and modify the web page contents from any client device on the network according to predetermined privilege data thereof, said method comprising the steps of:
receiving login data transmitted from the client device of the user;
checking whether the login data are contained in the predetermined privilege data and terminating the procedure if the login data are not contained therein;
transmitting the web page data to the client device according to the predetermined privilege of the login identity when the login data coincide with the ones recorded in the predetermined privilege data;
receiving the edited web page data transmitted from the client device; and
updating the web page data within the privilege of the login user according to the predetermined privilege data.

40. The method of claim 39, wherein the login data contains a username and the corresponding password.

41. The method of claim 39, wherein the login data contains assigned project items that include some or all web page contents within the privilege of the login user.

42. The method of claim 41, wherein the step of transmitting web page contents within the privilege of the login user transmits some or all of the web page contents in the assigned project.

43. The method of claim 39 further comprising a privilege analysis step after the login data are verified to be valid according to the predetermined privilege data and before the web page data within the login user's privilege are transmitted to the client device, wherein the privilege analysis step determines the privileged web page contents that can be edited and modified by the login user.

44. The method of claim 39 further comprising the step of reading in a user editing record file after the login data are verified to be valid according to the predetermined privilege data and before the web page data within the login user's privilege are transmitted to the client device, wherein the user editing record file contains the editing records previously finished by the user.

45. The method of claim 44 further comprising the step of updating the user editing record file after the step of receiving web page data.

46. The method of claim 44 further comprising the step of analyzing web page relations after reading in the user editing record file and before transmitting the web page data allowed within the login user's privilege to the client device, the web page relations including the related web pages and elements referred by links and hyperlinks and the storage locations and paths thereof in the user privileged web pages.

47. The method of claim 46 further comprising the step of displaying a list of privileged web pages after the step of analyzing web page relations and before transmitting the web page data within the login user's privilege to the client device, wherein the privileged web page list contains the privileged web pages and related web pages that can be edited and modified by the user according to his privilege.

48. The method of claim 47 further comprising the step of receiving user download selection information after displaying the web page list and before transmitting the web page data within the user's privilege to the client device, wherein the user download selection information contains a list of assigned web pages to be edited requested by the user.

49. The method of claim 48 further comprising the step of making a download list after receiving the user download selection information and before transmitting the web page data within the user privilege to the client device, wherein the download list contains the assigned web page list in the user download selection information as requested by the user.

50. The method of claim 49 further comprising the step of analyzing web page contents after the user download selection information is received and before the web page data within the user's privilege are transmitted to the client device, wherein the step of analyzing web page contents analyzes all elements contained in each of the assigned web pages to be edited to find out if it contains image data, voice data, video data, animation data, text data, Java applets, and ActiveX elements.

51. The method of claim 50, wherein the step of transmitting the web page data within the user's privilege to the client device transmits the image data if the assigned web page to be edited contains image data.

52. The method of claim 50, wherein the step of transmitting the web page data within the user's privilege to the client device transmits the voice data if the assigned web page to be edited contains voice data.

53. The method of claim 50, wherein the step of transmitting the web page data within the user's privilege to the client device transmits the video data if the assigned web page to be edited contains video data.

54. The method of claim 50, wherein the step of transmitting the web page data within the user's privilege to the client device transmits the animation data if the assigned web page to be edited contains animation data.

55. The method of claim 50, wherein the step of transmitting the web page data within the user's privilege to the client device transmits the text data if the assigned web page to be edited contains text data.

56. The method of claim 50, wherein the step of transmitting the web page data within the user's privilege to the client device transmits the Java elements if the assigned web page to be edited contains Java applets.

57. The method of claim 50, wherein the step of transmitting the web page data within the user's privilege to the client device transmits the ActiveX elements if the assigned web page to be edited contains ActiveX elements.

58. The method of claim 39, wherein the step of transmitting the web page data within the privilege of the login identity transmits HTML files.

59. The method of claim 39, wherein the step of receiving the web page data transmitted from the client device is executed after receiving the user's request for uploading data.

60. The method of claim 39, wherein the step of receiving web page data further comprises a privilege analysis step which determines web page contents that can be modified by the login user.

61. The method of claim 39, wherein the step of receiving web page data further comprises the step of analyzing web page relations in order to detect all related web pages and elements referred through links and hyperlinks and the storage locations and paths thereof in the assigned modified web page.

62. The method of claim 39, wherein the step of receiving web page data further comprises the step of displaying a list of edited web pages, wherein the edited web page list contains all edited and modified web pages in the assigned web pages to be edited.

63. The method of claim 62, wherein the step of receiving web page data further comprises the step of making an upload list after receiving the user upload selection information, the upload list contains the edited web pages to be uploaded as requested by the user in the user upload selection information.

64. The method of claim 63 further comprising the step of making an upload list after receiving the user upload selection information, wherein the upload list contains edited web pages to be uploaded requested in the user selection information.

65. The method of claim 64 further comprising the step of analyzing web page contents after the user download selection information is received, wherein the step of analyzing web page contents analyzes all elements contained in each of the edited web pages to find out if it contains modified image data, voice data, video data, animation data, text data, Java applets, and ActiveX elements.

66. The method of claim 65, wherein the system receives the edited image data if the image data in the edited web page are modified.

67. The method of claim 65, wherein the system receives the edited voice data if the voice data in the edited web page are modified.

68. The method of claim 65, wherein the system receives the edited video data if the video data in the edited web page are modified.

69. The method of claim 65, wherein the system receives the edited animation data if the animation data in the edited web page are modified.

70. The method of claim 65, wherein the system receives the edited text data if the text data in the edited web page are modified.

71. The method of claim 65, wherein the system receives the edited Java elements if the Java applets in the edited web page are modified.

72. The method of claim 65, wherein the system receives the edited ActiveX elements if the Active elements in the edited web page are modified.

73. The method of claim 39, wherein the step of receiving web page data comprises the step of receiving HTML files.

74. The method of claim 39, wherein the method is applied to a network system selected from the group comprising the local area network (LAN) system, the wide area network (WAN) system, the Internet system; and the cable television network system.

75. A method of editing and accessing web page contents of a website through a network, which comprises the steps of:
connecting to a computer system that manages the web page data;
registering privilege;
selecting download web pages;
receiving the selected download web page data;
editing the downloaded web page data; and
transmitting the edited web page data to the computer system that manages the web page data.

76. The method of claim 75, wherein the step of privilege registering further comprises the step of entering user identity data and verification data.

77. The method of claim 75, wherein the step of selecting download web pages is done by clicking in the web page list provided by the computer system that manages the web page data.

78. The method of claim 75, wherein the step of transmitting the edited web page data to the computer system that manages the web page data further comprises the step of selecting edited upload web pages.

79. The method of claim 75, wherein the step of selecting edited upload web pages is done by clicking in a web page list provided by the computer system that manages the web page data.
